(19) United States
(12) Patent Application Publication
(10) Pub. No.: US 2013/0203573 A1
(43) Pub. Date: Aug. 8, 2013

(54) ELECTRICALLY CONDUCTIVE RUBBER COMPOSITION, AND TRANSFER ROLLER PRODUCED BY USING THE COMPOSITION

(71) Applicant: SUMITOMO RUBBER INDUSTRIES, LTD., Kobe-shi (JP)

(72) Inventors: Naoyuki SATOYOSHI, Kobe-shi (JP); Yusuke TANIO, Kobe-shi (JP)

(73) Assignee: SUMITOMO RUBBER INDUSTRIES, LTD., Kobe-shi (JP)

(21) Appl. No.: 13/681,169

(22) Filed: Nov. 19, 2012

(30) Foreign Application Priority Data
Feb. 2, 2012 (JP) 2012-020984

(51) Int. Cl. H01B 1/12; F16C 13/00

(52) U.S. Cl. CPC H01B 1/125; F16C 13/00
USPC 492/59; 252/500

(57) ABSTRACT

An inventive electrically conductive rubber composition comprises a rubber component at least including an SBR, an EPDM and an epichlorohydrin rubber, a crosslinking agent component for crosslinking the rubber component, and a foaming agent component. The foaming agent component comprises a foaming agent alone in a proportion of not less than 0.1 part by mass and not greater than 8 parts by mass based on 100 parts by mass of the rubber component. Alternatively, the foaming agent component comprises the aforementioned proportion of the foaming agent and not greater than 5 parts by mass of a urea foaming assisting agent based on 100 parts by mass of the rubber component. An inventive transfer roller (1) includes a tubular roller body (2) formed from the electrically conductive rubber composition.

### TECHNICAL FIELD

The present invention relates to an electrically conductive rubber composition. The present invention further relates to a transfer roller which includes a tubular roller body produced by crosslinking and foaming the electrically conductive rubber composition and is to be incorporated in an electrophotographic image forming apparatus.

### BACKGROUND ART

In an electrophotographic image forming apparatus such as a laser printer, an electrostatic copying machine, a plain paper facsimile machine or a printer-copier-facsimile multifunction machine, for example, an image is generally formed on a surface of a sheet (the term “sheet” is herein defined to include a paper sheet, a plastic film such as an OHP film and the like, and this definition is effective in the following description) through the following process steps.

First, a surface of a photoreceptor body having a photoconductivity is evenly electrically charged and, in this state, exposed to light, whereby an electrostatic latent image corresponding to an image to be formed on the surface of the sheet is formed on the surface of the photoreceptor body (charging step and exposing step).

Then, a toner (minute color particles) preliminarily electrically charged to a predetermined potential is brought into contact with the surface of the photoreceptor body. Thus, the toner selectively adheres to the surface of the photoreceptor body according to the potential pattern of the electrostatic latent image, whereby the electrostatic latent image is developed into a toner image (developing step).

Subsequently, the toner image is transferred onto the surface of the sheet (transfer step), and fixed to the surface of the sheet (fixing step). Thus, the image is formed on the surface of the sheet.

In the transfer step, the toner image formed on the surface of the photoreceptor body may be directly transferred to the surface of the sheet, or may be once transferred to a surface of an image carrier (first transfer step) and then transferred to the surface of the sheet (second transfer step).

A transfer roller including a tubular roller body formed from an electrically conductive rubber composition and having a predetermined roller resistance is used for transferring the toner image from the surface of the photoreceptor body to the surface of the sheet in the transfer step, for transferring the toner image from the surface of the photoreceptor body to the surface of the image carrier in the first transfer step, or for transferring the toner image from the surface of the image carrier to the surface of the sheet in the second transfer step.

In the transfer step for the direct transfer, for example, a predetermined transfer voltage is applied between the photoreceptor body and the transfer roller pressed against each other with a predetermined pressing force and, in this state, the sheet is passed between the photoreceptor body and the transfer roller, whereby the toner image formed on the surface of the photoreceptor body is transferred to the surface of the sheet.

Transfer rollers to be incorporated in general-purpose laser printers and the like particularly for use in developing countries have recently been required to have a simplified construction so as to be produced at lower costs possibly by using versatile materials.

If the transfer rollers can be produced as having a simplified construction at lower costs by using the versatile materials, the laser printers and the like will become prevalent in the developing countries, thereby correspondingly promoting and accelerating office automation and factory automation. As a result, the technology levels of the developing countries may be improved, consequently contributing to alleviation and solution of the so-called North-South issue.

To meet the requirement, transfer rollers including a porous roller body, for example, are widely used. The porous roller body requires a reduced amount of a material to suppress material costs, and has a reduced weight to reduce transportation costs.

The porous roller body is produced by using an electrically conductive rubber composition prepared, for example, by blending a crosslinking agent component, a foaming agent component and the like with a rubber component including a crosslinkable rubber and an ion-conductive rubber, and kneading the resulting mixture.

Particularly, the roller body is preferably produced, for example, by extruding the electrically conductive rubber composition into an elongated tubular body by means of an extruder, continuously feeding the extruded tubular body in the elongated state without cutting the tubular body to pass the tubular body through a continuous crosslinking apparatus including a microwave crosslinking device and a hot air crosslinking device to continuously crosslink and foam the tubular body, and then cutting the tubular body to a predetermined length. This is advantageous to improve the productivity of the roller body and reduce the production costs of the transfer roller.

A porous roller body disclosed in JP2006-227500A is produced through the process steps described above by using an electrically conductive rubber composition prepared by blending a foaming agent component including an azodicarbonamide foaming agent and a urea foaming assisting agent and a crosslinking agent component with a rubber component including an acrylonitrile butadiene rubber (NBR) as a crosslinkable rubber and an epichlorohydrin rubber as an ion-conductive rubber.

A porous roller body disclosed in JP2002-221859A is produced through the process steps described above by using an electrically conductive rubber composition prepared by blending a foaming agent component including an azodicarbonamide foaming agent and a urea foaming assisting agent and a crosslinking agent component with a rubber component including an NBR as a crosslinkable rubber and an epichlorohydrin rubber and/or an ethylene oxide-propylene oxide-allyl glycidyl ether terpolymer as an ion-conductive rubber.

The porous roller body is generally required to have the greatest possible foam cell diameter to improve the sheet chargeability and prevent the toner transfer unevenness in the transfer step described above or to reduce the weight of the transfer roller and reduce the use amount of the material for the production of the roller body at lower costs. However, the roller bodies produced by using the electrically conductive rubber compositions described above do not satisfy the requirement.

That is, the urea foaming assisting agent is blended in the electrically conductive rubber compositions to promote the foaming of the electrically conductive rubber compositions by decomposition of the foaming agent so as to provide a uniform porous structure substantially free from the foaming unevenness in the crosslinking/foaming step in which the tubular body is passed through the continuous crosslinking apparatus described above.

In the roller bodies produced by using the electrically conductive rubber compositions, therefore, the decomposition temperature of the foaming agent is reduced by the action of the urea foaming assisting agent, thereby improving the uniformity of foam cells of the porous structure. However, the roller bodies tend to have smaller cell diameters, failing to satisfy the requirement described above.

In the prior-art electrically conductive rubber compositions, only the NBR which is a polar rubber serving to assist the ion-conductive feature is blended as the crosslinkable rubber for use in combination with the ion-conductive rubber. However, a less expensive and more versatile material than the NBR is desirably used as the crosslinkable rubber.

### SUMMARY OF THE INVENTION

### Problem to be Solve by the Invention

It is an object of the present invention to provide an electrically conductive rubber composition which contains versatile materials and can be used for producing a roller body having a greater foam cell diameter than the prior-art roller bodies by crosslinking and foaming the composition in a continuous crosslinking apparatus including a microwave crosslinking device and a hot air crosslinking device. It is another object of the present invention to provide a transfer roller including a roller body formed from the electrically conductive rubber composition.

### Solution to Problem

The present invention provides an electrically conductive rubber composition which can be crosslinked and foamed in a continuous crosslinking apparatus including a microwave crosslinking device and a hot air crosslinking device, the electrically conductive rubber composition comprising: a rubber component at least including a styrene butadiene rubber (SBR), an ethylene propylene diene rubber (EPDM) and an epichlorohydrin rubber; a crosslinking agent component for crosslinking the rubber component; and a foaming agent component; wherein the foaming agent component comprises a foaming agent alone in a proportion of not less than 0.1 part by mass and not greater than 8 parts by mass based on 100 parts by mass of the rubber component, or the foaming agent component comprises the aforementioned proportion of the foaming agent and not greater than 5 parts by mass of a urea foaming assisting agent based on 100 parts by mass of the rubber component.

The present invention also provides a transfer roller which includes a tubular roller body formed from the electrically conductive rubber composition.

According to the present invention, the SBR and the EPDM are used in combination instead of the conventional NBR as a crosslinkable rubber together with the epichlorohydrin rubber. This permits the roller body to have excellent ozone resistance, and further reduces material costs.

That is, the SBR is more versatile and less expensive than the NBR, and has a lower electrical resistivity than the NBR. Therefore, the proportion of the epichlorohydrin rubber required for production of a transfer roller having the same roller resistance can be reduced, thereby reducing the material costs.

However, the SBR has insufficient resistance to ozone generated inside a laser printer or the like, i.e., has poorer ozone resistance. Therefore, the EPDM is used in combination with the SBR in the present invention.

The EPDM per se does not only have excellent ozone resistance, but also serves to suppress degradation of the SBR due to ozone, thereby significantly improving the ozone resistance of the roller body.

According to the present invention, the foaming agent component for foaming the rubber component does not comprise the urea foaming assisting agent which serves to reduce the foam cell diameter as described above, but comprises only the foaming agent which is thermally decomposed to foam. Even if the urea foaming assisting agent is blended in the composition, the proportion of the urea foaming assisting agent is not greater than 5 parts by mass based on 100 parts by mass of the rubber component. This makes it possible to increase the foam cell diameter of the roller body as compared with the prior art.

In a production method using the continuous crosslinking apparatus, a tubular body formed by extruding the rubber composition into a tubular shape is generally uniformly heated.

If the urea foaming assisting agent is blended to reduce the decomposition temperature of the foaming agent, therefore, particles of the foaming agent are simultaneously and uniformly decomposed to foam in the generally entire tubular body in a short period of time from the start of the heating, whereby expansion of foam cells due to the foaming is suppressed by expansion power of adjacent foam cells. As a result, the foam cell diameter of the porous structure is reduced.

Where the urea foaming assisting agent is not blended or the proportion of the urea foaming assisting agent is limited in the aforementioned range to elevate the decomposition temperature of the foaming agent, particles of the foaming agent contained in the tabular body are decomposed to foam at different timings even with the generally entire tubular body being substantially uniformly heated. More specifically, the individual foaming agent particles are decomposed to foam at different timings due to various factors such as differences in the area of contact with the rubber component between the foaming agent particles due to differences in diameter, shape and position in the tubular body.

Almost all the foaming agent particles in the tubular body are finally decomposed to foam when the tubular body is passed through the continuous crosslinking apparatus, but the number of foaming agent particles simultaneously decomposed to start foaming is reduced. Therefore, foam cells being expanded by the foaming are less likely to suppress the expansion of adjacent foam cells by their expansion power. This increases the foam cell diameter of the roller body.

The proportion of the foaming agent of the foaming agent component in the inventive electrically conductive rubber composition is limited within a range not less than 0.1 part by mass and not greater than 8 parts by mass based on 100 parts by mass of the rubber component. If the proportion of the foaming agent is less than the aforementioned range, the amount of the foaming agent is basically insufficient, making it impossible to sufficiently foam the rubber component by the decomposition of the foaming agent. Therefore, the roller body fails to have the porous structure.

If the proportion of the foaming agent is greater than the aforementioned range, the number of foaming agent particles substantially simultaneously decomposed to start foaming in the tubular body is increased even without the blending of the urea foaming assisting agent or even with the proportion of the urea foaming assisting agent limited within the aforementioned range. As a result, the foam cells being expanded by the foaming are more likely to suppress the expansion of adjacent foam cells by their expansion power. This makes it impossible to sufficiently increase the foam cell diameter of the roller body.

In the inventive electrically conductive rubber composition, the rubber component preferably includes at least one polar rubber selected from the group consisting of an acrylonitrile butadiene rubber, a chloroprene rubber, a butadiene rubber and an acryl rubber. This makes it possible to finely control the roller resistance of the transfer roller. As will be apparent from the results for Examples to be described later, a possibly uniform porous structure without foaming unevenness can be provided.

The roller body of the inventive transfer roller is preferably produced by extruding the electrically conductive rubber composition into a tubular body and continuously crosslinking and foaming the tubular body in the continuous crosslinking apparatus including the microwave crosslinking device and the hot air crosslinking device. This makes it possible to improve the productivity of the roller body to further reduce the production costs of the transfer roller.

### Effects of the Invention

The present invention provides the electrically conductive rubber composition which contains versatile materials and can be used for producing a roller body having a greater foam cell diameter than the prior-art roller bodies by crosslinking and foaming the composition in the continuous crosslinking apparatus including the microwave crosslinking device and the hot air crosslinking device. The present invention further provides the transfer roller including the roller body formed from the electrically conductive rubber composition.

### BRIEF DESCRIPTION OF THE DRAWINGS

FIG. 1 is a perspective view showing the appearance of a transfer roller according to one embodiment of the present invention.

FIG. 2 is a block diagram for briefly explaining a continuous crosslinking apparatus to be used in production of the transfer roller.

FIG. 3 is a diagram for explaining how to measure the roller resistance of the transfer roller.

### EMBODIMENTS OF THE INVENTION

### <<Electrically Conductive Rubber Composition>>

The inventive electrically conductive rubber composition contains a rubber component at least including an SBR, an EPDM and an epichlorohydrin rubber, a crosslinking agent component for crosslinking the rubber component, and a foaming agent component. The foaming agent component includes a foaming agent alone in a proportion of not less than 0.1 part by mass and not greater than 8 parts by mass based on 100 parts by mass of the rubber component. Alternatively, the foaming agent component includes the aforementioned proportion of the foaming agent and not greater than 5 parts by mass of a urea foaming assisting agent based on 100 parts by mass of the rubber component.

### <SBR>

Usable as the SBR are various SBRs synthesized by copolymerizing styrene and 1,3-butadiene by an emulsion polymerization method, a solution polymerization method, and the like. The SBRs include those of an oil-extension type having flexibility controlled by addition of an extension oil, and those of a non-oil-extension type containing no extension oil. Either type of SBRs is usable.

According to the styrene content, the SBRs are classified into a higher styrene content type, an intermediate styrene content type and a lower styrene content type, and any of these types of SBRs is usable. Physical properties of the roller body can be controlled by changing the styrene content and the crosslinking degree.

These SBRs may be used either alone or in combination.

Where the rubber component includes the three types of rubbers including the SBR, the EPDM and the epichlorohydrin rubber and includes no polar rubber, the proportion of the SBR to be blended is preferably not less than 40 parts by mass and not greater than 90 parts by mass, particularly preferably not less than 60 parts by mass and not greater than 80 parts by mass, based on 100 parts by mass of the rubber component. Where the rubber component includes a polar rubber, the proportion of the SBR is preferably not less than 30 parts by mass and not greater than 50 parts by mass based on 100 parts by mass of the rubber component depending on the proportion of the polar rubber.

If the proportion of the SBR is less than the aforementioned range, the advantageous features of the SBR, i.e., higher versatility, lower costs and lower electrical resistivity, cannot be ensured.

If the proportion of the SBR is greater than the aforementioned range, the proportion of the EPDM is relatively reduced, making it impossible to impart the roller body with excellent ozone resistance. Further, the proportion of the epichlorohydrin rubber is also relatively reduced, making it impossible to impart the roller body with excellent ion conductivity.

Where an oil-extension SBR is used, the proportion of the SBR described above is defined as the solid proportion of the SBR contained in the oil-extension SBR.

### <EPDM>

Usable as the EPDM are various EPDMs each prepared by introducing double bonds to a main chain thereof by employing a small amount of a third ingredient (diene) in addition to ethylene and propylene. Various products containing different types of third ingredients in different amounts are commercially available. Typical examples of the third ingredients include ethylidene norbornene (ENB), 1,4-hexadiene (1,4-HD) and dicyclopentadiene (DCP). A Ziegler catalyst is typically used as a polymerization catalyst.

The proportion of the EPDM to be blended is preferably not less than 5 parts by mass and not greater than 40 parts by mass, particularly preferably not greater than 20 parts by mass, based on 100 parts by mass of the rubber component.

If the proportion of the EPDM is less than the aforementioned range, it will be impossible to impart the roller body with excellent ozone resistance.

If the proportion of the EPDM is greater than the aforementioned range, on the other hand, the proportion of the SBR is relatively reduced, so that the advantageous features of the SBR, i.e., higher versatility, lower costs and lower electrical resistivity, cannot be ensured. Further, the proportion of the epichlorohydrin rubber is relatively reduced, making it impossible to impart the roller body with excellent ion conductivity.

### <Epichlorohydrin Rubber>

Examples of the epichlorohydrin rubber include epichlorohydrin homopolymers, epichlorohydrin-ethylene oxide bipolymers (ECO), epichlorohydrin-propylene oxide bipolymers, epichlorohydrin-allyl glycidyl ether bipolymers, epichlorohydrin-ethylene oxide-allyl glycidyl ether terpolymers (GECO), epichlorohydrin-propylene oxide-allyl glycidyl ether terpolymers and epichlorohydrin-ethylene oxide-propylene oxide-allyl glycidyl ether quaterpolymers, which may be used either alone or in combination.

Of the aforementioned examples, copolymers containing ethylene oxide, particularly the ECO and/or the GECO are preferred as the epichlorohydrin rubber.

These copolymers preferably each have an ethylene oxide content of not less than 30 mol % and not greater than 80 mol %, particularly preferably not less than 50 mol %.

Ethylene oxide functions to reduce the roller resistance of the transfer roller. If the ethylene oxide content is less than the aforementioned range, however, it will be impossible to sufficiently provide the roller resistance reducing function and hence to sufficiently reduce the roller resistance of the transfer roller.

If the ethylene oxide content is greater than the aforementioned range, on the other hand, ethylene oxide is liable to be crystallized, whereby the segment motion of molecular chains is hindered to even increase the roller resistance of the transfer roller. Further, the roller body is liable to have a higher hardness after the crosslinking, and the electrically conductive rubber composition is liable to have a higher viscosity when being heat-melted before the crosslinking.

The ECO has an epichlorohydrin content, which is a balance obtained by subtracting the ethylene oxide content from the total. That is, the epichlorohydrin content is preferably not less than 20 mol % and not greater than 70 mol %, particularly preferably not greater than 50 mol %.

The GECO preferably has an allyl glycidyl ether content of not less than 0.5 mol % and not greater than 10 mol %, particularly preferably not less than 2 mol % and not greater than 5 mol %.

Ally glycidyl ether per se functions as side chains of the copolymer to provide a free volume, whereby the crystallization of ethylene oxide is suppressed to reduce the roller resistance of the transfer roller. However, if the allyl glycidyl ether content is less than the aforementioned range, it will be impossible to provide the roller resistance reducing function and hence to sufficiently reduce the roller resistance of the transfer roller.

Allyl glycidyl ether also functions as crosslinking sites during the crosslinking of the GECO. Therefore, if the allyl glycidyl ether content is greater than the aforementioned range, the crosslinking density of the GECO is increased, whereby the segment motion of molecular chains is hindered. This may even increase the roller resistance of the transfer roller. Further, the transfer roller is liable to suffer from reduction in tensile strength, fatigue resistance and flexural resistance.

The GECO has an epichlorohydrin content, which is a balance obtained by subtracting the ethylene oxide content and the allyl glycidyl ether content from the total. That is, the epichlorohydrin content is preferably not less than 10 mol % and not greater than 69.5 mol %, particularly preferably not less than 19.5 mol % and not greater than 60 mol %.

Examples of the GECO include copolymers of the three comonomers described above, in a narrow sense, as well as known modification products obtained by modifying an epichlorohydrin-ethylene oxide copolymer (ECO) with allyl glycidyl ether. In the present invention, any of these GECOs are usable.

The proportion of the epichlorohydrin rubber to be blended is preferably not less than 5 parts by mass and not greater than 40 parts by mass, particularly preferably not less than 10 parts by mass and not greater than 30 parts by mass, based on 100 parts by mass of the rubber component.

If the proportion of the epichlorohydrin rubber is less than the aforementioned range, it will be impossible to impart the roller body with excellent ion conductivity.

If the proportion of the epichlorohydrin rubber is greater than the aforementioned range, on the other hand, the proportion of the SBR is relatively reduced. Therefore, the advantageous features of the SBR, i.e., higher versatility, lower costs and lower electrical resistivity, cannot be ensured. Further, the proportion of the EPDM is also relatively reduced, making it impossible to impart the roller body with excellent ozone resistance.

### <Polar Rubber>

The roller resistance of the roller body can be finely controlled by blending the polar rubber.

Further, a possibly uniform porous structure free from foaming unevenness can be provided.

Examples of the polar rubber include NBRs, CRs, BRs and ACMs, which may be used either alone or in combination. Particularly, the NBRs and/or the CRs are preferred.

According to the acrylonitrile content, the NBRs are classified into a lower acrylonitrile content type, an intermediate acrylonitrile content type, an intermediate to higher acrylonitrile content type, a higher acrylonitrile content type and a very high acrylonitrile content type. Any of these types of NBRs may be used

The CRs are synthesized, for example, by polymerizing chloroprene by an emulsion polymerization method. According to the type of a molecular weight adjusting agent to be used for the emulsion polymerization, the CRs are classified into a sulfur modification type and a non-sulfur-modification type. According to the crystallization speed, the CRs are classified into a lower crystallization speed type, an intermediate crystallization speed type and a higher crystallization speed type. Any of these types of CRs may be used.

The proportion of the polar rubber to be blended may be properly determined according to the target roller resistance of the roller body. The proportion of the polar rubber is preferably not less than 5 parts by mass and not greater than 40 parts by mass, particularly preferably not less than 20 parts by mass, based on 100 parts by mass of the rubber component.

If the proportion of the polar rubber is less than the aforementioned range, it will be impossible to finely control the roller resistance of the roller body and to provide the foaming unevenness preventing effect.

If the proportion of the polar rubber is greater than the aforementioned range, the proportion of the SBR is relatively reduced and, therefore, the advantageous features of the SBR, i.e., higher versatility, lower costs and lower electrical resistivity, cannot be ensured. Further, the proportion of the EPDM is relatively reduced, making it impossible to impart the roller body with excellent ozone resistance. In addition, the proportion of the epichlorohydrin rubber is relatively reduced, making it impossible to impart the roller body with excellent ion conductivity.

### <Foaming Component>

The foaming agent is used alone as the foaming agent component in a proportion of not less than 0.1 part by mass and not greater than 8 parts by mass based on 100 parts by mass of the rubber component. Alternatively, the aforementioned proportion of the foaming agent and not greater than 5 parts by mass of the urea foaming assisting agent based on 100 parts by mass of the rubber component are used in combination as the foaming agent component.

If the proportion of the foaming agent is less than the aforementioned range, the amount of the foaming agent is basically insufficient, making it impossible to sufficiently foam the rubber component by decomposition of the foaming agent. Therefore, the roller body fails to have a porous structure.

If the proportion of the foaming agent is greater than the aforementioned range, on the other hand, the number of particles of the foaming agent substantially simultaneously decomposed to start foaming in a tubular body is increased even without the blending of the urea foaming assisting agent or even with the proportion of the urea foaming assisting agent limited within the aforementioned range. As a result, foam cells being expanded by the foaming are more likely to suppress the expansion of adjacent foam cells by their expansion power. This makes it impossible to sufficiently increase the foam cell diameter of the roller body.

Where the proportion of the foaming agent is not less than 0.1 part by mass and not greater than 8 parts by mass based on 100 parts by mass of the rubber component, in contrast, the roller body can have a porous structure sufficiently foamed as having a greater foam cell diameter.

In order to further improve the aforementioned effect, the proportion of the foaming agent is preferably not greater than 6 parts by mass in the aforementioned range.

If the proportion of the urea foaming assisting agent is greater than the aforementioned range, the decomposition temperature of the foaming agent is reduced. Therefore, the foaming agent particles are liable to be substantially simultaneously and uniformly decomposed to foam in the generally entire tubular body in a short period of time from the start of the heating, whereby the foam cells being expanded by the foaming are more likely to suppress the expansion of adjacent foam cells by their expansion power. As a result, the foam cell diameter of the porous structure is reduced.

The lower limit of the proportion of the urea foaming assisting agent to be blended is 0 part by mass. In order to increase the foam cell diameter, it is most preferred that the urea foaming assisting agent is not blended as the foaming component. In order to improve the uniformity of foam cell diameters, the urea foaming assisting agent may be blended in a small amount within the aforementioned range. The urea foaming assisting agent is preferably blended in the smallest possible proportion within the aforementioned range, preferably in a proportion of not greater than 3 parts by mass within the aforementioned range.

Any of various foaming agents capable of emanating a gas by heating to foam the electrically conductive rubber composition are usable as the foaming agent.

Specific examples of the foaming agents include azodicarbonamide (H₂NOCN═NCONH₂, ADCA), 4,4′-oxybis(benzenesulfonylhydrazide) (OBSH) and N,N-dinitrosopentamethylene tetramine (DPT), which may be used either alone or in combination.

Urea (H₂NCONH₂) is preferably used as the urea foaming assisting agent.

### <Crosslinking Component>

The crosslinking component for crosslinking the rubber component includes a crosslinking agent and an accelerating agent.

Examples of the crosslinking agent include a sulfur crosslinking agent, a thiourea crosslinking agent, a triazine derivative crosslinking agent, a peroxide crosslinking agent and various monomers, which may be used either alone or in combination. Among these crosslinking agents, the sulfur crosslinking agent is preferred.

Examples of the sulfur crosslinking agent include sulfur powder and organic sulfur-containing compounds. Examples of the organic sulfur-containing compounds include tetramethylthiuram disulfide and N,N-dithiobismorpholine. Sulfur such as the sulfur powder is particularly preferred.

The proportion of the sulfur crosslinking agent to be blended is preferably not less than 0.2 parts by mass and not greater than 5 parts by mass, particularly preferably not less than 1 part by mass and not greater than 3 parts by mass, based on 100 parts by mass of the rubber component.

If the proportion of the sulfur crosslinking agent is less than the aforementioned range, the electrically conductive rubber composition is liable to have a lower crosslinking speed as a whole, requiring a longer period of time for the crosslinking to reduce the productivity of the roller body. If the proportion of the sulfur crosslinking agent is greater than the aforementioned range, the roller body is liable to have a higher compression set after the crosslinking, or an excess amount of the sulfur crosslinking agent is liable to bloom on an outer peripheral surface of the roller body.

Examples of the accelerating agent include inorganic accelerating agents such as lime, magnesia (MgO) and litharge (PbO), and organic accelerating agents, which may be used either alone or in combination.

Examples of the organic accelerating agents include: guanidine accelerating agents such as di-o-tolylguanidine, 1,3-diphenylguanidine, 1-o-tolylbiguanide and a di-o-tolylguanidine salt of dicatechol borate; thiazole accelerating agents such as 2-mercaptobenzothiazole and di-2-benzothiazyl disulfide; sulfenamide accelerating agents such as N-cyclohexyl-2-benzothiazylsulfenamide; thiuram accelerating agents such as tetramethylthiuram monosulfide, tetramethylthiuram disulfide, tetraethylthiuram disulfide and dipentamethylenethiuram tetrasulfide; and thiourea accelerating agents, which may be used either alone or in combination.

According to the type of the crosslinking agent to be used, at least one optimum accelerating agent is selected from the various accelerating agents described above for use in combination with the crosslinking agent. For use in combination with the sulfur crosslinking agent, the accelerating agent is preferably selected from the thiuram accelerating agents and the thiazole accelerating agents.

Different types of accelerating agents have different crosslinking accelerating mechanisms and, therefore, are preferably used in combination. The proportions of the accelerating agents to be used in combination may be properly determined, and are preferably not less than 0.1 part by mass and not greater than 5 parts by mass, particularly preferably not less than 0.5 parts by mass and not greater than 2 parts by mass, based on 100 parts by mass of the rubber component.

The crosslinking agent component may further include an acceleration assisting agent.

Examples of the acceleration assisting agent include: metal compounds such as zinc white; fatty acids such as stearic acid, oleic acid and cotton seed fatty acids; and other conventionally known acceleration assisting agents, which may be used either alone or in combination.

The proportion of the acceleration assisting agent to be blended is properly determined according to the types and combination of the rubbers of the rubber component, and the types and combination of the crosslinking agent and the accelerating agent.

### <Other Components>

As required, various additives may be added to the electrically conductive rubber composition. Examples of the additives include an acid accepting agent, a plasticizing component (a plasticizer, a processing aid and the like), a degradation preventing agent, a filler, an anti-scorching agent, a UV absorbing agent, a lubricant, a pigment, an anti-static agent, a flame retarder, a neutralizing agent, a nucleating agent, a co-crosslinking agent and the like.

In the presence of the acid accepting agent, chlorine-containing gases generated from the epichlorohydrin rubber during the crosslinking of the rubber component is prevented from remaining in the roller body. Thus, the acid accepting agent functions to prevent the inhibition of the crosslinking and the contamination of the photoreceptor body, which may otherwise be caused by the chlorine-containing gases.

Any of various substances serving as acid acceptors may be used as the acid accepting agent. Preferred examples of the acid accepting agent include hydrotalcites and Magsarat which are excellent in dispersibility. Particularly, the hydrotalcites are preferred.

Where any of the hydrotalcites is used in combination with magnesium oxide or potassium oxide, a higher acid accepting effect can be provided, thereby more reliably preventing the contamination of the photoreceptor body.

The proportion of the acid accepting agent to be blended is preferably not less than 0.2 parts by mass and not greater than 5 parts by mass, particularly preferably not less than 0.5 parts by mass and not greater than 2 parts by mass, based on 100 parts by mass of the rubber component.

If the proportion of the acid accepting agent is less than the aforementioned range, it will be impossible to sufficiently provide the effect described above by the blending of the acid accepting agent. If the proportion of the acid accepting agent is greater than the aforementioned range, the roller body is liable to have an increased hardness after the crosslinking.

Examples of the plasticizing component include plasticizers such as dibutyl phthalate (DBP), dioctyl phthalate (DOP) and tricresyl phosphate, and waxes such as polar waxes. Examples of the processing aid include fatty acids such as stearic acid.

The proportion of the plasticizing component to be blended is preferably not greater than 5 parts by mass based on 100 parts by mass of the rubber component. This prevents contamination of the photoreceptor body, for example, when the transfer roller is mounted in an image forming apparatus or when the image forming apparatus is operated. For this purpose, it is particularly preferred to use any of the polar waxes as the plasticizing component.

Examples of the degradation preventing agent include various anti-aging agents and anti-oxidants.

The anti-oxidants serve to reduce the environmental dependence of the roller resistance of the transfer roller and to suppress increase in roller resistance during continuous energization of the transfer roller. Examples of the anti-oxidants include nickel diethyldithiocarbamate (NOCRAC (registered trade name) NEC-P available from Ouchi Shinko Chemical Industrial Co., Ltd.) and nickel dibutyldithiocarbamate (NOCRAC NBC available from Ouchi Shinko Chemical Industrial Co., Ltd.)

Examples of the filler include zinc oxide, silica, carbon, carbon black, clay, talc, calcium carbonate, magnesium carbonate and aluminum hydroxide, which may be used either alone or in combination.

The blending of the filler improves the mechanical strength and the like of the roller body.

Electrically conductive carbon black may be used as the filler to impart the roller body with electrical conductivity.

The proportion of the filler to be blended is preferably not less than 5 parts by mass and not greater than 50 parts by mass, particularly preferably not greater than 20 parts by mass, based on 100 parts by mass of the rubber component.

Examples of the anti-scorching agent include N-cyclohexylthiophthalimide, phthalic anhydride, N-nitrosodiphenylamine and 2,4-diphenyl-4-methyl-1-pentene, which may be used either alone or in combination. Particularly, N-cyclohexylthiophthalimide is preferred.

The proportion of the anti-scorching agent to be blended is preferably not less than 0.1 part by mass and not greater than 5 parts by mass, particularly preferably not greater than 1 part by mass, based on 100 parts by mass of the rubber component.

The co-crosslinking agent serves to crosslink itself as well as the rubber component to increase the overall molecular weight.

Examples of the co-crosslinking agent include ethylenically unsaturated monomers typified by methacrylates, metal salts of methacrylic acid and acrylic acid, polyfunctional polymers utilizing functional groups of 1,2-polybutadienes, and dioximes, which may be used either alone or in combination.

Examples of the ethylenically unsaturated monomers include:

(a) monocarboxylic acids such as acrylic acid, methacrylic acid and crotonic acid;
(b) dicarboxylic acids such as maleic acid, fumaric acid and itaconic acid;
(c) esters and anhydrides of the unsaturated carboxylic acids (a) and (b);
(d) metal salts of the monomers (a) to (c);
(e) aliphatic conjugated dienes such as 1,3-butadiene, isoprene and 2-chloro-1,3-butadiene;
(f) aromatic vinyl compounds such as styrene, α-methylstyrene, vinyltoluene, ethylvinylbenzene and divinylbenzene;
(g) vinyl compounds such as triallyl isocyanurate, triallyl cyanurate and vinylpyridine each having a hetero ring; and
(h) cyanovinyl compounds such as (meth)acrylonitrile, α-chloroacrylonitrile, acrolein, formyl sterol, vinyl methyl ketone, vinyl ethyl ketone and vinyl butyl ketone. These ethylenically unsaturated monomers may be used either alone or in combination.

Monocarboxylates are preferred as the esters (c) of the unsaturated carboxylic acids.

Specific examples of the monocarboxylates include: alkyl(meth)acrylates such as methyl(meth)acrylate, ethyl(meth)acrylate, n-propyl(meth)acrylate, i-propyl(meth)acrylate, n-butyl(meth)acrylate, i-butyl(meth)acrylate, n-pentyl(meth)acrylate, i-pentyl(meth)acrylate, n-hexyl(meth)acrylate, cyclohexyl(meth)acrylate, 2-ethylhexyl(meth)acrylate, octyl(meth)acrylate, i-nonyl(meth)acrylate, tert-butylcyclohexyl(meth)acrylate, decyl(meth)acrylate, dodecyl(meth)acrylate, hydroxymethyl(meth)acrylate and hydroxyethyl(meth)acrylate;

aminoalkyl(meth)acrylates such as aminoethyl(meth)acrylate, dimethylaminoethyl(meth)acrylate and butylaminoethyl(meth)acrylate;

(meth)acrylates such as benzyl(meth)acrylate, benzoyl(meth)acrylate and aryl(meth)acrylates each having an aromatic ring;

(meth)acrylates such as glycidyl(meth)acrylate, methaglycidyl(meth)acrylate and epoxycyclohexyl(meth)acrylate each having an epoxy group;

(meth)acrylates such as N-methylol(meth)acrylamide, γ-(meth)acryloxypropyltrimethoxysilane, tetrahalide furfuryl methacrylate each having a functional group; and

multifunctional (meth)acrylates such as ethylene glycol di(meth)acrylate, trimethylolpropane tri(meth)acrylate, ethylene dimethacrylate (EDMA), polyethylene glycol dimethacrylate and isobutylene dimethacrylate. These monocarboxylates may be used either alone or in combination.

The electrically conductive rubber composition containing the aforementioned ingredients can be prepared in a conventional manner. First, the rubbers for the rubber component are blended in the predetermined proportions, and the resulting rubber component is simply kneaded. After additives other than the foaming agent component and the crosslinking agent component are added to and kneaded with the rubber component, the foaming agent component and the crosslinking agent component are finally added to and further kneaded with the resulting mixture. Thus, the electrically conductive rubber composition is provided. A kneader, a Banbury mixer, an extruder or the like, for example, is usable for the kneading.

### <<Transfer Roller>>

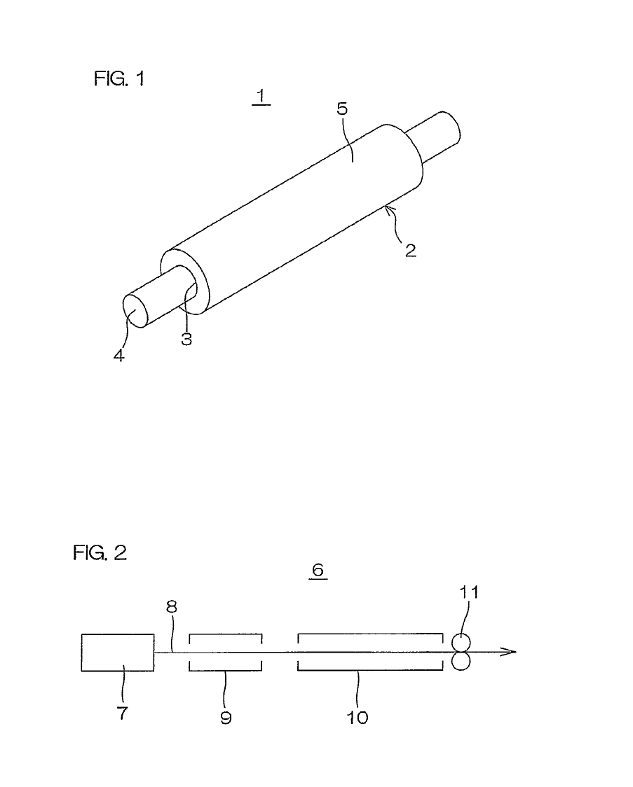

FIG. 1 is a perspective view showing the appearance of a transfer roller according to one embodiment of the present invention.

Referring to FIG. 1, the transfer roller 1 includes a cylindrical roller body 2 having a single layer structure, and a shaft 4 inserted through a center hole 3 of the roller body 2.

The shaft 4 is a unitary member made of a metal such as aluminum, an aluminum alloy or a stainless steel. The roller body 2 and the shaft 4 are bonded to each other, for example, with an electrically conductive adhesive agent to be thereby electrically connected to each other and mechanically fixed to each other for unitary rotation.

As described above, the roller body 2 is preferably produced by extruding the inventive electrically conductive rubber composition into an elongated tubular body by means of an extruder, continuously feeding the extruded tubular body in the elongated state without cutting the tubular body to pass the tubular body through a continuous crosslinking. apparatus including a microwave crosslinking device and a hot air crosslinking device to continuously crosslink and foam the tubular body, then cutting the tubular body to a predetermined length and, as required, polishing an outer peripheral surface 5 of the resulting roller body.

FIG. 2 is a block diagram for briefly explaining an example of the continuous crosslinking apparatus.

Referring to FIGS. 1 and 2, the continuous crosslinking apparatus 6 includes a microwave crosslinking device 9, a hot air crosslinking device 10 and a take-up device 11 provided in this order on a continuous transportation path along which an elongated continuous tubular body 8 formed by continuously extruding the electrically conductive rubber composition by an extruder 7 for the roller body 2 of the transfer roller 1 is continuously transported in the elongated state without cutting by a conveyor (not shown) or the like. The take-up device 11 is adapted to take up the tubular body 8 at a predetermined speed.

The ingredients are mixed together and kneaded. The resulting electrically conductive rubber composition is formed into a ribbon shape, and continuously fed into the extruder 7 to be continuously extruded into an elongated tubular body 8 by operating the extruder 7.

In turn, the tubular body 8 formed by the extrusion is continuously transported at a predetermined speed by the conveyor and the take-up device 11 to be passed through the microwave crosslinking device 9 of the continuous crosslinking apparatus 6, whereby the electrically conductive rubber composition of the tubular body 8 is crosslinked to a certain crosslinking degree by irradiation with microwave. Further, the inside of the microwave crosslinking device 9 is heated to a predetermined temperature, whereby the electrically conductive rubber composition is further crosslinked, and the foaming agent is decomposed to foam the electrically conductive rubber composition.

Subsequently, the tubular body 8 is further transported to be passed through the hot air crosslinking apparatus 10, whereby hot air is applied to the tubular body 8. Thus, the electrically conductive rubber composition is further foamed by decomposition of the foaming agent, and crosslinked to a predetermined crosslinking degree.

Then, the tubular body 8 is passed through cooling water not shown to be cooled. Thus, a crosslinking/foaming step is completed, in which the tubular body 8 is crosslinked and foamed.

The detail of the continuous crosslinking apparatus 6 is described, for example, in JP2006-227500A and JP2002-221859A.

The tubular body 8 formed from the electrically conductive rubber composition as having a crosslinking degree and a foaming degree each controlled at a desired level can be continuously provided by properly setting the transportation speed of the tubular body 8, the microwave irradiation dose of the microwave crosslinking device 9, the setting temperature and the length of the hot air crosslinking device 10, and the like (the microwave crosslinking device 9 and the hot air crosslinking device 10 may be each divided into a plurality of sections, and microwave irradiation doses and setting temperatures at these sections may be changed stepwise).

The tubular body 8 being transported may be twisted to uniformize the microwave irradiation dose and the heating degree throughout the entire tubular body as much as possible to uniformize the crosslinking degree and the foaming degree throughout the entire tubular body.

Thereafter, the tubular body 8 is cut to a predetermined length and, as required, the outer peripheral surface 5 of the resulting tubular body 8 is polished. Thus, a porous roller body 2 is produced. The tubular body 8 may be wound up, for example, by a winding device not shown to be once stored and, as demanded, the roller body 2 may be produced by performing the cutting step and the subsequent step.

A continuous crosslinking process is thus performed with the use of the continuous crosslinking apparatus 6, thereby improving the productivity of the roller body 2 and further reducing the production costs of the transfer roller 1.

### <Foam Cell Diameter>

Since the porous roller body 2 is produced by using the inventive electrically conductive rubber composition, the roller body 2 has a foam cell diameter that is greater than the prior-art roller bodies.

The foam cell diameter of the roller body 2 is not particularly limited, but is preferably not less than 300 μm, particularly preferably not less than 400 μm in order to improve the sheet chargeability and prevent the toner transfer unevenness in the transfer step, to reduce the weight of the transfer roller 1 and to reduce the production costs by reducing the amounts of the materials to be used.

If the foam cell diameter is excessively great, the resulting image is liable to suffer from white voids due to toner transfer failure. Therefore, the foam cell diameter is preferably not greater than 1 mm, particularly preferably not greater than 800 μm, within the aforementioned range.

In the present invention, the foam cell diameter is expressed by a value determined through a measurement method described in Examples.

### <Roller Resistance>

The transfer roller 1 including the roller body 2 preferably has a roller resistance of not greater than 10¹⁰Ω, particularly preferably not greater than 10⁹Ω, as measured at an application voltage of 1000 V under an ordinary temperature/ordinary humidity environment at a temperature of 23° C. at a relative humidity of 55%.

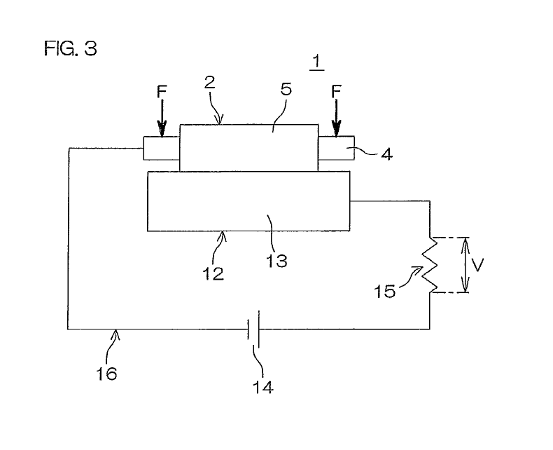

FIG. 3 is a diagram for explaining how to measure the roller resistance of the transfer roller 1.

Referring to FIGS. 1 and 3, the roller resistance is expressed by a value determined through the following measurement method in the present invention.

An aluminum drum 12 rotatable at a constant rotation speed is prepared, and the outer peripheral surface 5 of the roller body 2 of the transfer roller 1 to be subjected to the measurement of the roller resistance is brought into abutment against an outer peripheral surface 13 of the aluminum drum 12 from above.

A DC power source 14 and a resistor 15 are connected in series between the shaft 4 of the transfer roller 1 and the aluminum drum 12 to provide a measurement circuit 16. The DC power source 14 is connected to the shaft 4 at its negative terminal, and connected to the resistor 15 at its positive terminal. The resistor 15 has a resistance r of 100Ω.

Subsequently, a load F of 500 g is applied to opposite end portions of the shaft 4 to bring the roller body 2 into press contact with the aluminum drum 12 and, in this state, a detection voltage V applied to the resistor 15 is measured by applying an application voltage E of 1000 V from the DC power source 14 between the shaft 4 and the aluminum drum 12 while rotating the aluminum drum 12 (at a rotation speed of 30 rpm).

The roller resistance R of the transfer roller 1 is determined from the following expression (i′) based on the detection voltage V and the application voltage E (=1000 V):

R=r×E/(V−r) (i′)

However, the term (−r) in the denominator of the expression (i′) is negligible, so that the roller resistance of the transfer roller 1 is expressed by a value determined from the following expression (i) in the present invention:

R=r×E/V (i)

### <Hardness and Other Physical Properties>

The roller body 2 preferably has an ASKER-C hardness of not higher than 50, particularly preferably about 35±5, as measured under an ordinary temperature/ordinary humidity environment at a temperature of 23° C. at a relative humidity of 55% by a measurement method specified by the Society of Rubber Industry Standards SRIS 0101 “Physical Test Methods for Expanded Rubber.”

If the ASKER-C hardness of the roller body 2 is higher than the aforementioned range, the roller body has an insufficient flexibility, making it impossible to provide a sufficiently great nip width to effectively improve the toner transfer efficiency and to effectively suppress damage to the photoreceptor body.

Further, the roller body 2 can be controlled as having a predetermined compression set and a predetermined dielectric dissipation factor. In order to control the compression set, the ASKER-C hardness, the roller resistance and the dielectric dissipation factor of the roller body 2, the types and the amounts of the ingredients of the rubber composition may be properly adjusted.

### EXAMPLES

### Example 1

### (Preparation of Rubber Composition)

A rubber component was prepared by blending 70 parts by mass of an SBR (JSR1502 available from JSR Co., Ltd.), 10 parts by mass of an EPDM (ESPRENE (registered trade name) EPDM505A available from Sumitomo Chemical Co., Ltd) and 20 parts by mass of an ECO (HYDRIN (registered trade name) T3108 available from Zeon Corporation).

A foaming agent component was prepared, which contained an ADCA foaming agent (available under the trade name of VINYFOR AC#3 from Eiwa Chemical Industry Co., Ltd.) alone in a proportion of 0.1 part by mass based on 100 parts by mass of the rubber component, but did not contain a urea foaming assisting agent.

A rubber composition was prepared by blending ingredients shown below in Table 1 with the rubber component and the foaming agent component, and kneading the resulting mixture by means of a Banbury mixer.

TABLE 1

| Ingredients | Parts by mass |
|---|---|
| Filler | 10 |
| Acid accepting agent | 1 |
| Crosslinking agent | 1.5 |
| Accelerating agent DM | 1.5 |
| Accelerating agent TS | 0.5 |

The ingredients shown in Table 1 are as follows:

Filler: Carbon black HAF
Acid accepting agent: Hydrotalcites (DHT-4A-2 available from Kyowa Chemical Industry Co., Ltd.)
Crosslinking agent: Sulfur powder
Accelerating agent DM: Di-2-benzothiazyl disulfide (SUNSINEMBTS available from Shandong Shanxian Chemical Co., Ltd.)
Accelerating agent TS: Tetramethylthiuram monosulfide (SANCELER available from Sanshin Chemical Industry Co., Ltd.)

### (Production of Transfer Roller)

The rubber composition was fed into an extruder, and extruded into an elongated tubular body having an outer diameter of 10 mm and an inner diameter of 3.0 mm by the extruder. The extruded tubular body 8 was continuously fed out in an elongated state without cutting to be continuously passed through the continuous crosslinking apparatus 6 including the microwave crosslinking device 9 and the hot air crosslinking device 10 shown in FIG. 2, whereby the rubber composition of the tubular body was continuously crosslinked and foamed. Then, the resulting tubular body was passed through cooling water to be continuously cooled.

The microwave crosslinking device 9 had an output of 6 to 12 kW and an internal control temperature of 150 to 250° C. The hot air crosslinking device 10 had an internal control temperature of 150 to 250° C. and an effective heating vessel length of 8 m.

The foamed tubular body 8 had an outer diameter of about 15 mm.

In turn, the tubular body 8 was cut to a predetermined length to provide a roller body 2. The roller body 2 was fitted around a 5-mm diameter shaft having an outer peripheral surface to which an electrically conductive thermosetting adhesive agent was applied, and heated at 160° C. for 60 minutes in an oven to cure the thermosetting adhesive. Thus, the roller body 2 was electrically connected to and mechanically fixed to the shaft 4.

After opposite end portions of the roller body 2 were cut, the outer peripheral surface 5 of the roller body 2 was polished by a traverse polishing process utilizing a cylindrical polisher to be thereby finished as having an outer diameter of 12.5 mm (with a tolerance of ±0.1 mm). Thus, a transfer roller 1 was produced.

### Examples 2 to 5 and Comparative Examples 2 and 3

Electrically conductive rubber compositions were prepared in substantially the same manner as in Example 1, except that the foaming agent component contained the ADCA foaming agent alone in proportions of 2 parts by mass (Example 2), 4 parts by mass (Example 3), 6 parts by mass (Example 4), 8 parts by mass (Example 5), 10 parts by mass (Comparative Example 2) and 12 parts by mass (Comparative Example 3) based on 100 parts by mass of the rubber component, but did not contain the urea foaming assisting agent. Then, transfer rollers were produced by using the electrically conductive rubber compositions thus prepared.

### Example 6

An electrically conductive rubber composition was prepared in substantially the same manner as in Example 1, except that the foaming agent component contained 4 parts by mass of the ADCA foaming agent and 2.5 parts by mass of the urea foaming assisting agent (available under the trade name of CELLPASTE 101 from Eiwa Chemical Industry Co., Ltd.) in combination. Then, a transfer roller was produced by using the electrically conductive rubber composition thus prepared.

### Example 7

An electrically conductive rubber composition was prepared in substantially the same manner as in Example 1, except that the foaming agent component contained 4 parts by mass of the ADCA foaming agent and 5 parts by mass of the urea foaming assisting agent in combination. Then, a transfer roller was produced by using the electrically conductive rubber composition thus prepared.

### Comparative Example 1

An electrically conductive rubber composition was prepared in substantially the same manner as in Example 1, except that the foaming agent component contained 4 parts by mass of the ADCA foaming agent and 6 parts by mass of the urea foaming assisting agent in combination. Then, a transfer roller was produced by using the electrically conductive rubber composition thus prepared.

### Example 8

An electrically conductive rubber composition was prepared in substantially the same manner as in Example 3, except that 30 parts by mass of an NBR (a lower acrylonitrile content NBR JSR N250L available from JSR Co., Ltd. and having an acrylonitrile content of 20%) was added as a polar rubber to the rubber component and the proportion of the SBR was changed to 40 parts by mass. Then, a transfer roller was produced by using the electrically conductive rubber composition thus prepared.

### Example 9

An electrically conductive rubber composition was prepared in substantially the same manner as in Example 3, except that 30 parts by mass of a CR (SHOPRENE (registered trade name) WRT available from Showa Denko K.K.) was added as a polar rubber to the rubber component and the proportion of the SBR was changed to 40 parts by mass. Then, a transfer roller was produced by using the electrically conductive rubber composition thus prepared.

### <Measurement of Foam Cell Diameter>

A predetermined area of the outer peripheral surface 5 of each of the roller bodies 2 produced in Examples and Comparative Examples was photographed by means of a microscope, and the resulting image was analyzed. That is, 50 foam cells were arbitrarily selected from the image, and the diameters of the 50 foam cells were measured and averaged. The average was defined as the foam cell diameter. The roller bodies were each evaluated for the foam cell diameter based on the following criteria:

⊚ (Excellent): The foam cell diameter was not less than 400 μm.
◯ (Acceptable): The foam cell diameter was not less than 300 μm and less than 400 μm.
x (Unacceptable): The foam cell diameter was less than 300 μm.

### <Evaluation for Foaming Unevenness>

The outer peripheral surface 5 of each of the roller bodies 2 produced in Examples and Comparative Examples was visually inspected circumferentially and longitudinally for foaming unevenness. The roller bodies were each evaluated for the foaming unevenness based on the following criteria:

⊚ (Excellent): Foaming unevenness was not observed throughout the outer peripheral surface.
◯ (Acceptable): Foaming unevenness was locally observed on the outer peripheral surface but with no practical problem.
x (Unacceptable): Foaming unevenness was observed throughout the outer peripheral surface.

The results are shown in Tables 2 and 3.

TABLE 2

| | Example 1 | Example 2 | Example 3 | Example 4 | Example 5 | Example 6 |
|---|---|---|---|---|---|---|
| Parts by mass | | | | | | |
| SBR | 70 | 70 | 70 | 70 | 70 | 70 |
| NBR | — | — | — | — | — | — |
| CR | — | — | — | — | — | — |
| ECO | 20 | 20 | 20 | 20 | 20 | 20 |
| EPDM | 10 | 10 | 10 | 10 | 10 | 10 |
| Foaming agent | 0.1 | 2 | 4 | 6 | 8 | 4 |
| Urea foaming assisting agent | — | — | — | — | — | 2.5 |
| Filler | 10 | 10 | 10 | 10 | 10 | 10 |
| Acid accepting agent | 1 | 1 | 1 | 1 | 1 | 1 |
| Crosslinking agent | 1.5 | 1.5 | 1.5 | 1.5 | 1.5 | 1.5 |
| Accelerating agent DM | 1.5 | 1.5 | 1.5 | 1.5 | 1.5 | 1.5 |
| Accelerating agent TS | 0.5 | 0.5 | 0.5 | 0.5 | 0.5 | 0.5 |
| Evaluation | | | | | | |
| Foam cell diameter | ⊚ | ⊚ | ⊚ | ⊚ | ◯ | ◯ |
| Foaming unevenness | ◯ | ◯ | ◯ | ◯ | ◯ | ◯ |

TABLE 3

| | | | | Comparative | Comparative | Comparative |
|---|---|---|---|---|---|---|
| | Example 7 | Example 8 | Example 9 | Example 1 | Example 2 | Example 3 |
| Parts by mass | | | | | | |
| SBR | 70 | 40 | 40 | 70 | 70 | 70 |
| NBR | — | 30 | — | — | — | — |
| CR | — | — | 30 | — | — | — |
| ECO | 20 | 20 | 20 | 20 | 20 | 20 |
| EPDM | 10 | 10 | 10 | 10 | 10 | 10 |
| Foaming agent | 4 | 4 | 4 | 4 | 10 | 12 |
| Urea foaming assisting agent | 5 | — | — | 6 | — | — |
| Filler | 10 | 10 | 10 | 10 | 10 | 10 |
| Acid accepting agent | 1 | 1 | 1 | 1 | 1 | 1 |
| Crosslinking agent | 1.5 | 1.5 | 1.5 | 1.5 | 1.5 | 1.5 |
| Accelerating agent DM | 1.5 | 1.5 | 1.5 | 1.5 | 1.5 | 1.5 |
| Accelerating agent TS | 0.5 | 0.5 | 0.5 | 0.5 | 0.5 | 0.5 |
| Evaluation | | | | | | |
| Foam cell diameter | ◯ | ⊚ | ⊚ | X | X | X |
| Foaming unevenness | ◯ | ⊚ | ⊚ | ◯ | ◯ | ◯ |

The results for Examples 1 to 9 and Comparative Examples 1 to 3 in Tables 2 and 3 indicate that, in order to increase the foam cell diameter of the porous roller body, the foaming agent should be used alone as the foaming agent component in a proportion of not less than 0.1 part by mass and not greater than 8 parts by mass based on 100 parts by mass of the rubber component, or the aforementioned proportion of the foaming agent and not greater than 5 parts by mass of the urea foaming assisting agent based on 100 parts by mass of the rubber component should be used in combination as the foaming agent component.

The results for Examples 1 to 5 and Examples 6 and 7 indicate that, in order to further increase the foam cell diameter, it is preferred to use the foaming agent alone as the foaming agent component in the aforementioned proportion without the use of the urea foaming assisting agent.

The results for Examples 1 to 7 and Examples 8 and 9 indicate that, in order to suppress the foaming unevenness while permitting the roller body to have a greater foam cell diameter, it is preferred to additionally blend the polar rubber as the rubber component.

This application corresponds to Japanese Patent Application No. 2012-020984 filed in the Japan Patent Office on Feb. 2, 2012, the disclosures of which are incorporated herein by reference in its entirety.

### DESCRIPTION OF REFERENCE CHARACTERS

1 TRANSFER ROLLER
2 ROLLER BODY
3 HOLE
4 SHAFT
5 OUTER PERIPHERAL SURFACE
6 CONTINUOUS CROSSLINKING APPARATUS
7 EXTRUDER
8 TUBULAR BODY
9 MICROWAVE CROSSLINKING DEVICE
10 HOT AIR CROSSLINKING DEVICE
11 TAKE-UP DEVICE
12 ALUMINUM DRUM
13 OUTER PERIPHERAL SURFACE
14 DC POWER SOURCE
15 RESISTOR
16 MEASUREMENT CIRCUIT

What is claimed is:

1. An electrically conductive rubber composition comprising:
a rubber component at least including a styrene butadiene rubber, an ethylene propylene diene rubber and an epichlorohydrin rubber;
a crosslinking agent component for crosslinking the rubber component; and
a foaming agent component;
wherein the foaming agent component comprises a foaming agent alone in a proportion of not less than 0.1 part by mass and not greater than 8 parts by mass based on 100 parts by mass of the rubber component.

2. An electrically conductive rubber composition comprising:
a rubber component at least including a styrene butadiene rubber, an ethylene propylene diene rubber and an epichlorohydrin rubber;
a crosslinking agent component for crosslinking the rubber component; and
a foaming agent component;
wherein the foaming agent component comprises not less than 0.1 part by mass and not greater than 8 parts by mass of a foaming agent and not greater than 5 parts by mass of a urea foaming assisting agent based on 100 parts by mass of the rubber component.

3. The electrically conductive rubber composition according to claim 1, wherein the rubber component includes at least one polar rubber selected from the group consisting of an acrylonitrile butadiene rubber, a chloroprene rubber, a butadiene rubber and an acryl rubber.

4. The electrically conductive rubber composition according to claim 1, which is crosslinked and foamed in a continuous crosslinking apparatus including a microwave crosslinking device and a hot air crosslinking device.

5. A transfer roller comprising a tubular roller body formed from an electrically conductive rubber composition as recited in claim 1.

6. The transfer roller according to claim 5, wherein the roller body is a roller body produced by extruding the electrically conductive rubber composition into a tubular body and continuously crosslinking and foaming the tubular body in a continuous crosslinking apparatus including a microwave crosslinking device and a hot air crosslinking device.

7. The electrically conductive rubber composition according to claim 2, wherein the rubber component includes at least one polar rubber selected from the group consisting of an acrylonitrile butadiene rubber, a chloroprene rubber, a butadiene rubber and an acryl rubber.

8. The electrically conductive rubber composition according to claim 7, which is crosslinked and foamed in a continuous crosslinking apparatus including a microwave crosslinking device and a hot air crosslinking device.

9. The electrically conductive rubber composition according to claim 2, which is crosslinked and foamed in a continuous crosslinking apparatus including a microwave crosslinking device and a hot air crosslinking device.

10. A transfer roller comprising a tubular roller body formed from an electrically conductive rubber composition as recited in claim 2.
